(19) United States
(12) Patent Application Publication
(10) Pub. No.: US 2020/0266534 A1
(43) Pub. Date: Aug. 20, 2020

(54) Read-Through Metal Tag and Methods of Making and Using the Same

(71) Applicants: Somnath MUKHERJEE, Milpitas, CA (US); Olle Jonny HAGEL, Linköping (SE)

(72) Inventors: Somnath MUKHERJEE, Milpitas, CA (US); Olle Jonny HAGEL, Linköping (SE)

(73) Assignee: Thin Film Electronics ASA, Oslo (SE)

(21) Appl. No.: 16/790,494

(22) Filed: Feb. 13, 2020

Related U.S. Application Data
(60) Provisional application No. 62/806,287, filed on Feb. 15, 2019.

(51) Int. Cl. H01Q 1/52; H04W 4/80; H01Q 1/22

(52) U.S. Cl. CPC H01Q 1/528; H01Q 1/2216; H04W 4/80

(57) ABSTRACT

Embodiments of the disclosure pertain to a wireless communication device and a method of reading a wireless communication device in which the magnitude of electromagnetically-induced currents in a metal-containing substrate is reduced. The metal-containing substrate has one or more openings therethrough. The device includes an antenna configured to (i) receive one or more first wireless signals from a reader and (ii) transmit or broadcast one or more second wireless signals and an integrated circuit coupled to the antenna. The antenna overlaps with at least one of the one or more openings.

### RELATED APPLICATION(S)

The present application claims priority to U.S. Provisional Pat. Appl. No. 62/806,287, filed Feb. 15, 2019 (Atty. Docket No. IDR5120-PR), incorporated herein by reference in its entirety.

### FIELD OF THE INVENTION

The present invention generally relates to the field(s) of wireless communication, identification and/or security devices (e.g., wireless communication tags, such as radio-frequency identification [RFID] tags, electronic article surveillance [EAS] tags, and near-field communication [NFC] tags). More specifically, embodiments of the present invention pertain to a wireless communication device including an antenna and a metal structure, such as a metal foil or blanket-deposited metal layer. The metal structure includes cuts or slits configured to reduce the effect of eddy currents in the metal structure on the magnetic flux of signals transmitted and received by the antenna.

### DISCUSSION OF THE BACKGROUND

Wireless communication tags, such as RFID and/or security tags, may include labels with printed electronics. The printed electronics may comprise an integrated circuit and an antenna, among other components. The integrated circuit may include a processor and a read-only memory (ROM), and may be attached to a substrate (e.g., a thin metal foil or other mechanical support structure).

Wireless communication tags typically cannot be encapsulated with or be in close-proximity to a metal sheet or foil (e.g., aluminum or steel), since eddy currents in the metal prevent RF communication with the antenna. A magnetic field emanating from the antenna induces the eddy currents, which in turn result in a magnetic field emanating from the metal sheet or foil. The magnetic field emanating from the metal sheet or foil opposes the magnetic field from the antenna (e.g., according to Lenz's law), thus compromising the performance of the antenna by decreasing magnetic flux and increasing the resonant frequency of the antenna.

In one solution, the metal sheet or foil may be used as an antenna for the wireless tag (e.g., by shaping it in a spiral form). However, this solution is not economically viable due to precision design rules for and stringent manufacturing tolerances of such spiral antennas. In another solution, a material that limits the interference of the metal sheet or foil (e.g., a ferrite) may be used. However, such a material may be too expensive to produce and/or use on a mass scale. Thus, it is desirable to find a less expensive and/or less onerous solution to reduce the effects of eddy currents in the metal sheet or foil, and consequently improve the performance of wireless tag antennas encapsulated with and/or behind a metal sheet or foil.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

To solve the problems outlined in the background, cuts or slits may be created in the metal-containing substrate to prevent the eddy currents (e.g., by rerouting moving electrons around the cuts or slits), thus improving performance of the antenna and allowing the wireless tag to be readable.

In one aspect, the present invention concerns a method of reading a wireless communication device, comprising placing a reader proximate to a first side of the wireless communication device, and transmitting or broadcasting one or more wireless signals to the wireless communication device. The wireless communication device comprises an antenna, a metal-containing substrate, and an integrated circuit on the metal-containing substrate and electrically coupled to the antenna. The first side of the wireless communication device contains the metal-containing substrate and is away from a second side of the wireless communication device that contains the antenna. The metal-containing substrate contains one or more openings therethrough. The opening(s) improve a readability of the wireless communication device and/or reduce a magnitude of electromagnetically-induced currents (e.g., eddy currents) in the metal-containing substrate. For example, the eddy currents may be reduced relative to an otherwise identical metal-containing substrate without the one or more openings. The antenna overlaps with at least one of the openings.

In some embodiments, the antenna is not co-planar with the metal-containing substrate. For example, the antenna may be parallel with the metal-containing substrate. However, in some examples, the antenna may not be more than 10 mm away from the metal-containing substrate. In some cases, the antenna is not more than 5 mm or more than 3 mm away from the metal-containing substrate.

In some embodiments, the one or more openings comprise a plurality of openings. For example, the plurality of openings may comprise at least 3 or 4 openings. In some cases, the plurality of openings comprises a pattern of openings, such as a radial pattern of cuts or slits. The radial pattern may, in some examples, further comprise an uncut center or hub, configured to maintain at least some mechanical integrity of the metal-containing substrate. In other or further examples, the metal-containing substrate further comprises one or more cross-cuts connecting at least one opening with the outermost edge of the metal-containing substrate.

In some alternative embodiments, the plurality of openings comprises a plurality of parallel cuts or slits. Such a pattern may, in some examples, further comprise one or more cross-cuts connecting (i) at least two of the parallel cuts or slits, or (ii) at least one of the parallel cuts or slits with an outermost edge of the metal-containing substrate. For example, the pattern may comprise at least three parallel cuts or slits, and the cross-cut(s) may connect each of the parallel cuts or slits with the outermost edge of the metal-containing substrate.

In some embodiments, the reader comprises a near field communication (NFC) reader. In other or further embodiments, the integrated circuit is configured to (i) receive and process one or more first signals from the antenna and (ii) generate and transmit one or more second signals to the antenna.

Another aspect of the present invention concerns a wireless communication device, comprising an antenna, an integrated circuit configured to receive one or more first wireless signals from the antenna and to transmit or broadcast one or more second wireless signals using the antenna, and a metal-containing substrate having one or more openings therethrough. The antenna overlaps with at least one of the opening(s).

In some embodiments, the opening(s) are configured to reduce and/or change a direction of eddy currents in the metal-containing substrate. The eddy currents may be reduced or directionally changed relative to an otherwise identical metal-containing substrate without the opening(s).

In other or further embodiments, the opening(s) comprise a pattern. For example, the pattern may comprise a radial pattern of cuts or slits. In some cases, the radial pattern further comprises an uncut center or hub, configured to maintain at least some mechanical integrity of the metal-containing substrate. Alternatively, the pattern may comprise a plurality of parallel cuts or slits. In some cases, the pattern further comprises one or more cross-cuts connecting (i) at least two of the parallel cuts or slits, or (ii) at least one of the parallel cuts or slits with an outermost edge of the metal-containing substrate. For example, the pattern may comprise at least three parallel cuts or slits, and the cross-cut(s) connect each of the parallel cuts or slits with the outermost edge of the metal-containing substrate. The metal-containing substrate may comprise such cross-cut(s) connecting at least one of the opening(s) with the outermost edge of the metal-containing substrate independent of any pattern of the opening(s).

A still further aspect of the present invention concerns a method of making a wireless communication device, comprising forming an integrated circuit on a metal-containing substrate, forming one or more openings through the metal-containing substrate, and coupling an antenna to the integrated circuit and placing the antenna so that the antenna overlaps with at least one of the opening(s). The opening(s) improve a readability of the wireless communication device and/or reduce a magnitude of electromagnetically-induced currents in the metal-containing substrate. In some embodiments, (i) the readability of the wireless communication device is improved and/or (ii) the magnitude of electromagnetically-induced currents in the metal-containing substrate is reduced relative to an otherwise identical metal-containing substrate without the opening(s).

As for the method of reading and the device, the antenna may be parallel with the metal-containing substrate and/or may be not more than 10 mm away from the metal-containing substrate. In various examples, the antenna is not more than 5 mm or 3 mm away from the metal-containing substrate.

In various embodiments, the opening(s) comprise a plurality of openings, and the openings may comprise a pattern. In some embodiments, forming the plurality of openings comprises cutting the metal of the metal-containing substrate. For example, cutting the metal of the metal-containing substrate may comprise stamping, laser-cutting, or patterning the metal-containing substrate.

In some examples, forming the plurality of openings comprises forming a radial pattern of cuts or slits in the metal-containing substrate. The radial pattern may further comprise an uncut center or hub, configured to maintain at least some mechanical integrity of the metal-containing substrate. Alternatively, forming the plurality of openings may comprise forming a plurality of parallel cuts or slits in the metal-containing substrate. In additional embodiments, forming the plurality of openings further comprises forming one or more cross-cuts connecting (i) at least two of the parallel cuts or slits and/or (ii) at least one of the parallel cuts or slits with an outermost edge of the metal-containing substrate. For example, the plurality of openings may comprise at least three parallel cuts or slits, and the cross-cut(s) may connect each of the parallel cuts or slits with the outermost edge of the metal-containing substrate. However regardless of the number or pattern of the openings, the method may further comprise forming one or more cross-cuts connecting at least one of the opening(s) with the outermost edge of the metal-containing substrate.

The present invention advantageously allows one to make a wireless tag on a metal substrate and read the wireless tag through the metal substrate, without significantly adversely affecting the read range of the tag in some cases. These and other advantages of the present invention will become readily apparent from the detailed description of various embodiments below.

### BRIEF DESCRIPTION OF THE DRAWINGS

FIGS. 1A-B show an exemplary wireless tag attached to a metal-containing substrate having cuts or slits in a radial pattern therein, in accordance with an embodiment of the present invention.

FIG. 2 is a simulation of eddy currents in the metal-containing substrate shown in FIG. 1.

FIG. 3 is a simulation of a magnetic field around the metal-containing substrate shown in FIG. 1.

FIG. 4 is a simulation of eddy currents in an exemplary metal-containing substrate having cuts or slits in a grating or parallel pattern therein.

FIG. 5 is a simulation of a magnetic field around the metal-containing substrate shown in FIG. 4.

FIGS. 6A-B show a wireless communication tag attached to an exemplary metal-containing substrate having cuts or slits in a radial pattern therein, in accordance with an embodiment of the present invention.

FIGS. 7A-D show metal-containing substrates having various radial patterns of cuts or slits, in accordance with embodiments of the present invention.

FIG. 8 shows the dimensions of the radial pattern of cuts and/or slits relative to the dimensions of an NFC tag, in accordance with embodiments of the present invention.

FIG. 9 is a simulation of eddy currents in an exemplary metal-containing substrate having a parallel pattern of cuts or slits therein.

FIG. 10 is a simulation of eddy currents in the metal-containing substrate shown in FIG. 9, but with additional transverse cuts or slits, in accordance with embodiments of the present invention.

FIG. 11 is a simulation of a magnetic field around the metal-containing substrate shown in FIG. 10.

FIGS. 12A-B show an exemplary wireless tag attached to exemplary metal-containing substrates having a grating or parallel pattern of cuts or slits with a transverse cut therein, in accordance with embodiments of the present invention.

FIGS. 13A-B show a metal-containing substrate before and after being cut in an exemplary internal pattern, in accordance with an embodiment of the present invention.

FIGS. 14A-C show exemplary metal-containing substrates each respectively having a square, cross, and a grating pattern therein, in accordance with embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

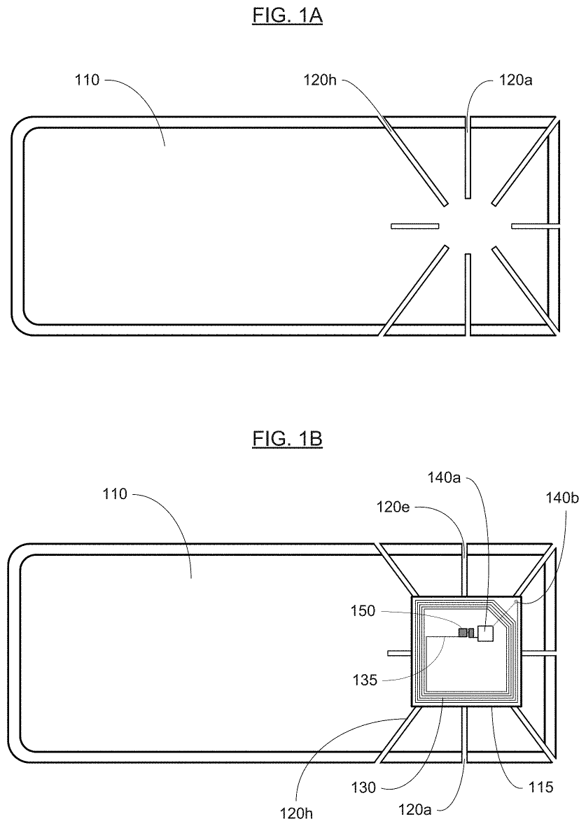

FIGS. 1A-B show a metal-containing substrate 110 having eight cuts or slits 120a-h and a wireless communication tag 115 attached to the substrate 110. The wireless tag 115 may comprise an antenna 130, an integrated circuit 150 (which may include a processor, one or more sensors, a battery and/or a memory, etc.), and connection pads 140a-b that connect the outer end of the antenna 130 to the integrated circuit. A trace 135 connects the inner end of the antenna 130 to the integrated circuit 150. Another trace (not shown) under the antenna 130 connects the connection pads 140a to the connection pad 140b, and may be insulated from the antenna 130 by a dielectric layer between the trace and the antenna 130. The processor may include a microprocessor, a signal processor, a controller, etc. The memory may store an identification number and overhead data or information.

The metal-containing substrate 110 may comprise a metal foil or layer (e.g., comprising aluminum, an aluminum alloy, or stainless steel). The cuts or slits 120a-h are configured to reduce eddy currents in the metal-containing substrate 110 when a wireless signal is transmitted or received by the antenna 130. The cuts or slits 120a-h may be made by milling, stamping, laser cutting, photolithographic patterning and etching, etc. Each of the cuts or slits 120a-h may have a length of from 5 to 50 mm (or any length or range of lengths of from 5 to 50 mm, e.g., 20 mm) and a width of from 0.5 to 5 mm (or any width or range of widths of from 0.5 to 5 mm, e.g., 2 mm). Metal may be retained in the center of the cuts or slits 120a-h in the substrate 110 for structural integrity, although having less metal overlapping with the wireless tag 115 may increase the readability of the wireless tag. The cuts or slits 120a-h may be cut to or beyond the periphery of the substrate 110, which further decreases eddy currents in the substrate 110 relative to cuts or slits that don't extend to the periphery of the substrate 110.

Table 1 shows the results of testing the readability (e.g., the maximum distance from which the reader may transmit and receive a signal to and from the wireless tag 115) of the wireless tag 115 when unattached and when attached to the substrate 110 (which, in the example shown in FIGS. 1A-B, comprises aluminum). An external capacitance across the antenna terminals of the tag 115 (shown in Table 1) was used to retune the tag 115 to the correct operating frequency.

TABLE 1

| | | Read range mm (max) | | |
|---|---|---|---|---|
| Tag assembly | External cap (pF) | Nexus 5X | Nexus 6 | iPhone 7 |
| Stand-alone | NA | 42.0 | 39.0 | 45.0 |
| Substrate 110 | 82 | 32.5 | 34.5 | 29.0 |

The tag 115 was read through the substrate 110 by three different readers, including the Google Nexus 5X and Nexus 6 smartphones and the Apple iPhone 7 smartphone. The capacitance of the wireless tag 115 attached to the substrate 110 is 82 picofarads. The aluminum substrate 110 decreases the read range of the wireless tag 115 by 9.5 mm using the Nexus 5X, by 4.5 mm using the Nexus 6, and by 16.0 mm using the iPhone 7. Thus, the wireless tag 115 is still adequately readable, even when attached to the metal-containing substrate 110.

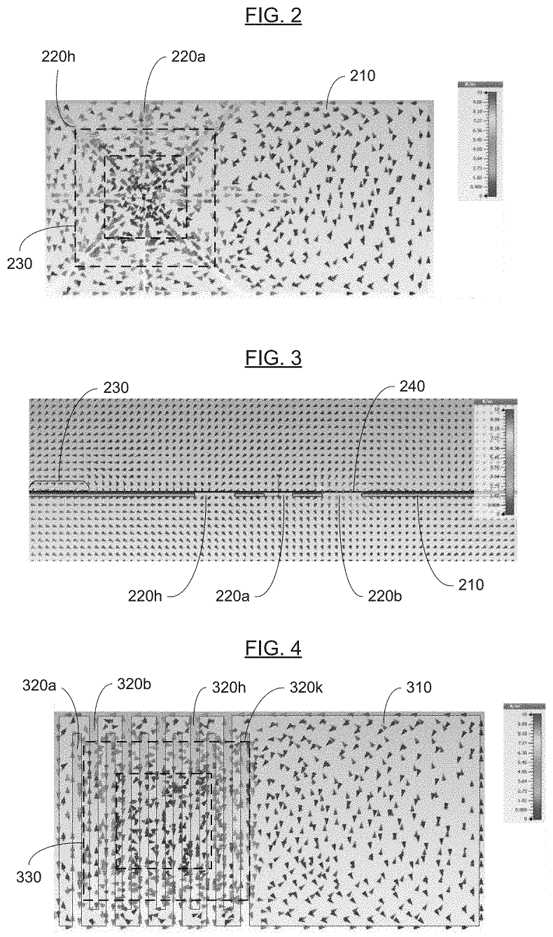

FIG. 2 is a simulation (e.g., using electromagnetic simulation software from Computer Simulation Technology GmbH, Darmstadt, Germany) that shows the eddy currents (represented by arrows) induced in the patterned substrate 210 by the wireless signal from an NFC reader. The frequency of the wireless signal is 13.56 MHz. The paths of the eddy currents are broken by the cuts or slits 220a-h, and the paths along the periphery of adjacent sections of the substrate 210 across the cuts or slits 220a-h tend to be in different directions, essentially offsetting each other. A color key on the right shows the magnitude of the current per unit length (A/m) for each arrow. The maximum current in the substrate 210 is 10 A/m.

The paths of the eddy currents in patterned substrate 210 are broken or at least redirected by the cuts or slits 220a-h. The eddy currents also have different, and in some cases opposing, directions near the cuts or slits 220a-h and elsewhere in the substrate 210. The eddy currents are generally weaker in areas or regions of the substrate 210 that overlap with the antenna 230 and/or that are along the cuts or slits 220a-h than in other areas or regions of the substrate 210.

FIG. 3 is a simulation made using the electromagnetic simulation software from Computer Simulation Technology GmbH (CST) that shows the magnetic field in a plane normal to the metal-containing substrate 210 when the eddy currents are induced by the 13.56 MHz wireless signal. The antenna 230 (part of which is obscured by the legend at the far right side of FIG. 3) surrounds the slits 220a, 220b and 220h. Thus, the center of this cross-section of the substrate 210 and slits 220a, 220b and 220h shown in FIG. 3 is from a region inside the antenna 230 (FIG. 2). The horizontal line 240 in FIG. 3 depicts the substrate on which the antenna is formed. The magnetic field vectors at the slits 220a, 220b and 220h indicate magnetic flux through the slits. Thus, a wireless signal from a reader is readable by the antenna. One objective of the present invention is to maximize the normal (i.e., perpendicular) component of the magnetic field (and therefore flux) in locations at or near the antenna. The slit geometry shown in FIGS. 1-2 provides at least in part such a magnetic field and flux. Widening the cuts or slits 220a-h and reducing the diameter of the hub increases readability (e.g., the read range) due to an increase in the normal component of the magnetic field, but may compromise mechanical integrity.

FIG. 4 is a simulation made using the electromagnetic simulation software from CST that shows eddy currents (represented by arrows) induced in a patterned substrate 310 by the 13.56 MHz wireless signal from an NFC reader. The substrate 310 may be similar or substantially identical to the substrate 210 shown in FIG. 2, except that the cuts or slits 320a-k forms a serpentine pattern in the substrate 310. The cuts or slits 320a-k are parallel to each other and/or in a grating pattern, and may be staggered and/or offset at opposite ends. A key on the right shows the magnitude of the current per unit length (A/m) for each arrow. The maximum current in the substrate 310 is 10 A/m.

The paths of the eddy currents in patterned substrate 310 are broken by the cuts or slits 320a-k. In addition, the eddy currents have different, and frequently opposing, directions, both near the cuts or slits 320a-k and elsewhere in the substrate 310. In some parts of the metal substrate 310 near or between the cuts or slits 320a-k, particularly inside the antenna 330 (the inner and outer outlines of which are designated by the dashed lines), the eddy currents partially or completely offset each other. While the eddy currents in areas or regions of the substrate 310 that overlap with the antenna 330 are stronger than in other areas or regions of the substrate 310 the region inside the antenna 330 has relatively weak eddy currents, similar in weakness to those in the region of the substrate 310 away from the antenna. In the region inside and surrounded by the antenna 330, the slits 320d-320h weaken the eddy currents in the substrate 310. The areas outside the antenna 330 also show relatively weak eddy currents, compared to the region of overlap between the antenna 330 and the substrate 310. The slits 320a-k reduce eddy current strength in the substrate 310 in the areas inside and outside of the antenna 330.

Each of the cuts or slits 320a-k may have a width of from 0.1% to 10% of the length of the substrate 310 (or any width or range of widths between 0.1% and 10% of the length of the substrate 310, e.g., 2%), and a length of from 50% to 95% of the width of the substrate 310 (or any length or range of lengths between 50% to 95% of the width of the substrate, e.g., 90%). The cuts or slits 320a-k may be cut to the periphery or edge on either or both of the opposing sides of the substrate 310. In alternative embodiments, the cuts or slits 320a-k may not be cut to the periphery of the substrate 310, and/or narrow cuts may be made parallel to the length of the substrate (e.g., in a direction perpendicular to the cuts of slits 320a-k.

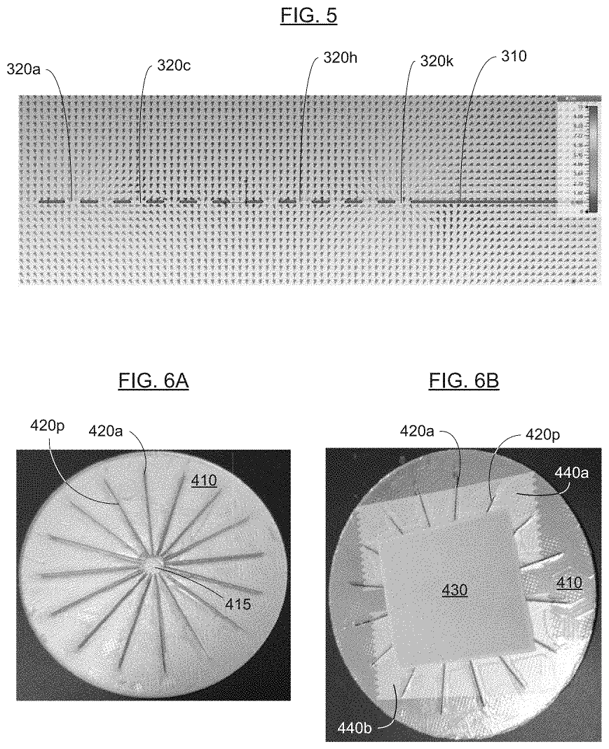

FIG. 5 is a simulation made using the electromagnetic simulation software from CST that shows the magnetic field in a plane normal to the metal-containing substrate 310 when the eddy currents are induced by a 13.56 MHz wireless signal from the reader (not shown). The reader is located at the bottom of the image (i.e., below the substrate 310), and the tag antenna (not shown) is located above the substrate 310. The normal component of the field is weakest above and below the uncut region of the substrate 310. However, a significant normal component of the field exists in the cut regions 320c to 320i. Although readability performance (e.g., read distance) is improved compared to the metal-containing substrate 210 shown in FIGS. 2 and 3, mechanical integrity is not as good.

FIGS. 6A-B show a metal substrate 410 having sixteen cuts or slits 420a-p made using a surgical knife or scalpel in a radial pattern extending from a center or hub 415 and a wireless communication tag 430 secured to the substrate 410 with tape 440a-b. The substrate 410 is aluminum foil having a thickness of 30 μm, but other metal foils or sheets and other thicknesses are also suitable. The cuts or slits 420a-p can also be made with an exacto knife, a box cutter, a razor blade, etc., which may be drawn along a straight edge (e.g., a ruler). FIG. 6A shows the front side with the substrate 410 closer to the reader, and FIG. 6B shows the backside with the metal foil or layer 410 away from the reader. The wireless tag 430 is attached directly to the foil or layer 410.

The wireless tag 430 may comprise an antenna and an integrated circuit (not visible) on a plastic (e.g., polyethylene terephthalate, or PET) substrate, and may be similar or substantially identical to the wireless tag 115 shown in FIGS. 1A-B. As shown, the wireless tag 430 is face-down on the metal foil or layer 410. The integrated circuit may be between the substrate 410 and the antenna, but other arrangements or relationships are also suitable. The metal foil or layer 410 as shown in FIGS. 6A-B comprises aluminum (e.g., an aluminum foil). Alternatively, the metal foil or layer 410 may comprise stainless steel, or a sputtered or evaporated layer of Al, Ti, Cr, Ni, Cu, Zn, Ag, Sn, Ta, W, Au, or an alloy thereof. Graphics may be on the front side of the metal foil or layer 410. The cuts or slits 420a-p are configured to reduce eddy currents in the metal-containing substrate 410 when a wireless signal is transmitted or received by the antenna in the wireless tag 430. The cuts or slits 420a-p may be made as described herein. The metal in the center or hub 415 of the foil or layer 410 maintains structural integrity of the metal foil or layer 410. The cuts or slits 420a-p do not extend all the way to the periphery of the metal foil or layer 410, also to maintain structural integrity of the metal foil or layer 410.

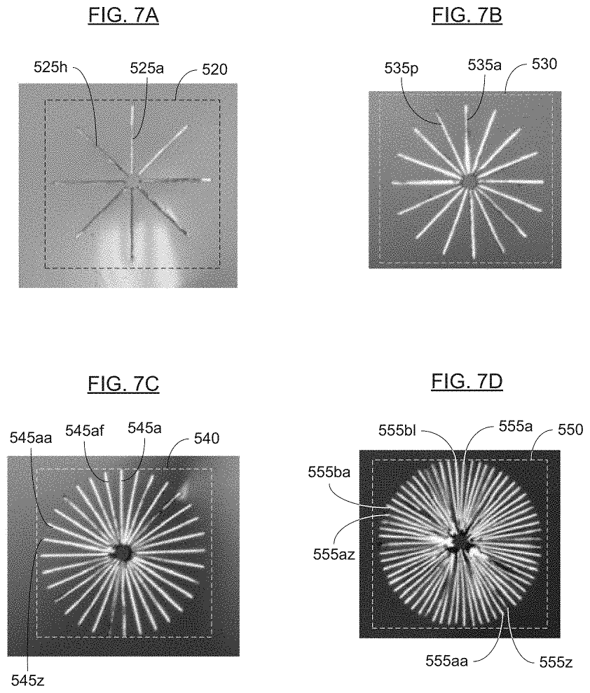

FIGS. 7A-D show various patterns of cuts and slits (each having a radial distribution) in a copper foil substrate. The copper foil may have a thickness of from 5 to 100 micrometers (or any thickness or range of thicknesses of from 5 to 100 micrometers, e.g., 30 micrometers). The pattern 520 (FIG. 7A) has eight cuts or slits 525a-h. The pattern 530 (FIG. 7B) has sixteen cuts or slits 535a-p. The pattern 540 (FIG. 7C) has thirty-two cuts or slits 545a-af. The pattern 550 (FIG. 7D) has sixty-four cuts or slits 555a-b1. Each of the cuts or slits 525a-h, 535a-p, 545a-af, or 555a-b1 may have a length of from 5% to 48% of the substrate (or any length or range of lengths of from 5% to 48% of the substrate, e.g., 42%). As shown in FIGS. 7A-D, as the number of cuts or slits in the substrate increases, the mechanical integrity of the substrate in the center of the pattern of cuts or slits may be progressively weaker, and/or the circular or substantially circular portion of the substrate at the inner ends of the cuts or slits may be progressively larger and/or non-uniform. In alternative embodiments, any of the patterns 520, 530, 540, and 550 may have a number of cuts or slits of from four to one hundred and twenty-eight.

A wireless tag attached to the copper foil with the pattern 530 was not readable. However, substantially identical wireless tags attached to the copper foils with the patterns 540 and 550 were readable. Therefore, the increasing the number of cuts or slits in a radial pattern in the metal substrate may increase the readability of the wireless tag.

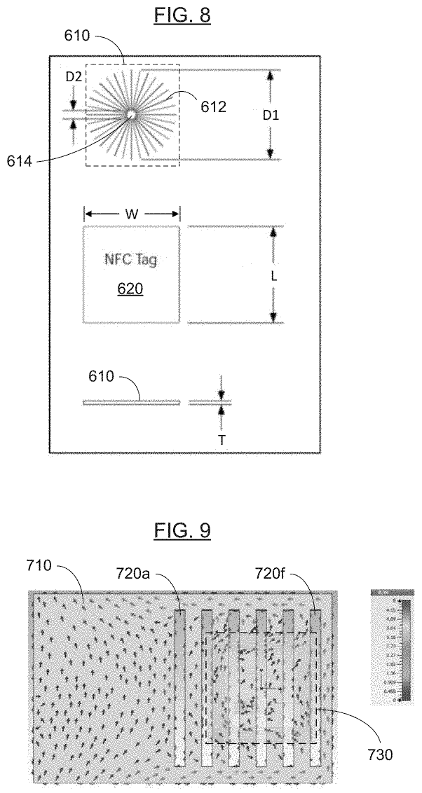

FIG. 8 shows a milling plate 610 having a radial pattern 612 thereon, an NFC tag 620 having a length L and a width W, and a cross-section of the milling plate 610. The milling plate 610 is used to transfer the pattern 612 onto a metal foil or an exposed metal layer of a metal-containing substrate. The radial pattern has a diameter D1 of from 10 to 400 mm and a center D2 of from 1 to 25 mm. In one example, D1 is 28 mm (i.e., the length of two colinear cuts or slits and the diameter D2 of the center or hub), and D2 is 3 mm, but the invention is not so limited. The thickness T of the cross-section 630 of the milling plate 610 of can be any value or range of values from 0.01 mm to 10 mm. In one example, T is about 0.3 mm.

The length L and width W of the NFC tag 620 are generally (but not always) greater than the diameter D1 of the radial pattern 612. The length L may be of from 5 to 100 mm, and the width W may be of from 5 to 100 mm. The width W may be the same as of less than the length L. In one example, each of the length L and width W of the NFC tag 620 is 30 mm.

FIG. 9 is a simulation made using the electromagnetic simulation software from CST that shows the eddy currents (represented by arrows) induced in a metal substrate 710 by the 13.56 MHz wireless signal from an NFC reader. The substrate 710 may be similar or substantially identical to the substrate 210 shown in FIGS. 2-3. The cuts or slits 720a-f are parallel to each other and/or in a grating pattern, and do not extend to the edge of the substrate 710. A key on the right shows the magnitude of the current per unit length (A/m) for each arrow. The maximum current in the substrate 710 is 5 A/m. Each of the six cuts or slits 720a-f may have the same or similar dimensions as the cuts or slits 320a-k shown in FIG. 4. In alternative embodiments, there may be four, eight, or sixteen cuts or slits 320a-k, etc. If more cuts or slits 720 are added to the same area as shown in FIG. 9, the width of each of the cuts and slits 720 are generally smaller than as shown.

The paths of the eddy currents in the metal substrate 710 are broken by cuts or slits 720a-f. In addition, the eddy currents have different directions near the cuts or slits 720a-f. In some parts of the metal substrate 710 near or between the cuts or slits 720a-f, particularly near or inside the antenna 730, the eddy currents partially or completely offset each other. The eddy currents are weaker (i) along the periphery of the substrate 710 near the cuts or slits 720a-f, and (ii) in areas or regions of the substrate 710 that overlap with the antenna 730.

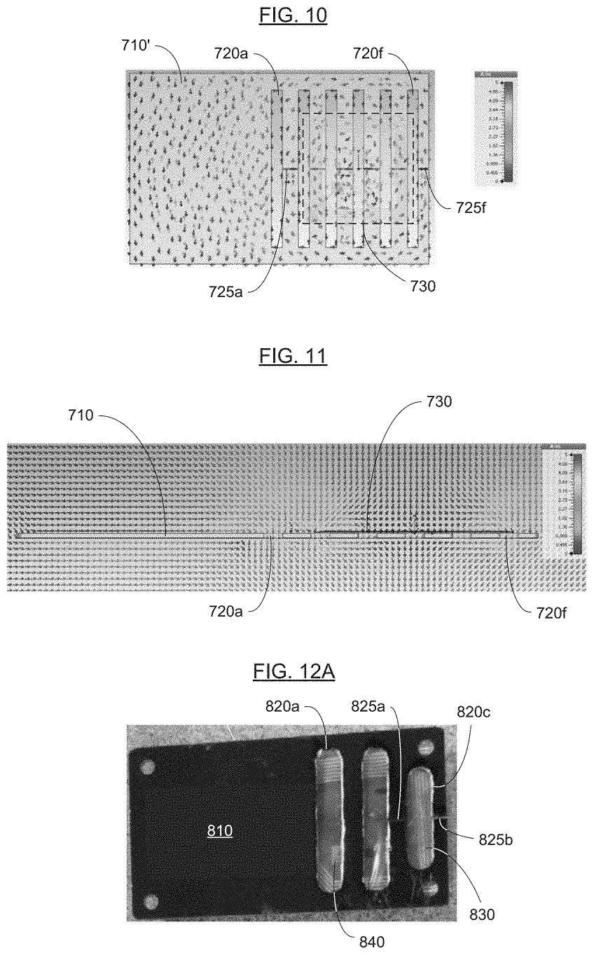

FIG. 10 is a simulation made using the electromagnetic simulation software from CST that shows the eddy currents (represented by arrows) induced in an alternative substrate 710′ by a 13.56 MHz wireless signal from an NFC reader. The substrate 710′ is similar to the substrate 710 shown in FIG. 9, except for the addition of narrow cross-cuts 725a-f that separate the strips of substrate 710′ between the cuts or slits 720a-f (and/or between the outermost cut or slit 720f and the outer periphery of the substrate 710′), and connect the cuts or slits 720a-f to the periphery of the substrate 710′ (e.g., with empty space). The narrow cross-cuts 725a-f may be in the center of the substrate 710′ and/or along the length of the substrate 710′ (e.g., the narrow cross-cuts 725a-f may be perpendicular to the main or primary cuts or slits 720a-f). A key on the right shows the magnitude of the current per length (A/m) for each arrow. The maximum current in the substrate 710 is 5 A/m.

The paths of the eddy currents in the substrate 710′ are further broken or redirected by the narrow cross-cuts 725a-f in addition to the main or primary cuts or slits 720a-f. the eddy currents have different (and in some cases, opposing) directions that at least partially offset each other. In addition to being weaker in areas or regions of the substrate 710′ that overlap with the antenna 730, the cross-cuts 725a-f also appear to weaken the eddy currents throughout the remainder of the substrate 710′. Along the narrow cross-cuts 725a-f, the eddy currents are relatively strong, but in opposite directions so that they effectively offset each other.

Each of the main/primary cuts or slits 720a-f may have a width of from 0.2% to 10% of the length of the substrate 810 (or any width or range of widths between 0.2% and 10%; e.g., 4%), and a length of from 50% to 95% of the width of the substrate 710 and/or 710′ (or any length or range of lengths between 50% to 95% of the width of the substrate; e.g., 85%). The narrow cross-cuts 725a-f may have a length less than or equal to the width of the strips of the substrate 710′ between the main/primary cuts or slits 720a-f (i.e., the cross-cuts 725a-f need not extend completely across the strips of the substrate 710′ between the main/primary cuts or slits 720a-f) and a width of 1-100% of the width of the main/primary cuts or slits 720a-f, although the invention is not so limited.

FIG. 11 is a simulation made using the electromagnetic simulation software from CST that shows the magnetic field in a plane normal to the substrate 710′ (shown in FIG. 10) when the eddy currents are induced by the 13.56 MHz wireless signal. The field strength on the tag side (i.e., near the antenna 730) is noticeably stronger than other geometries (e.g., of patterns of cuts or slits). The maximum magnetic field strength is 5 A/m.

The mechanical integrity and mechanical performance are comparable to embodiments shown in FIGS. 2-5, while electrical performance (e.g., the magnetic field) is considerably better. To further improve mechanical integrity, the outermost cross-cut 725f can be omitted and/or the cross-cuts 725a-f can be made only partially across the strips of the substrate between the main/primary cuts or slits 720a-720f Placement of the wireless tag inside the outermost primary cuts 720a and 720f can minimize the adverse effects of the metal substrate 710 on signal transmission.

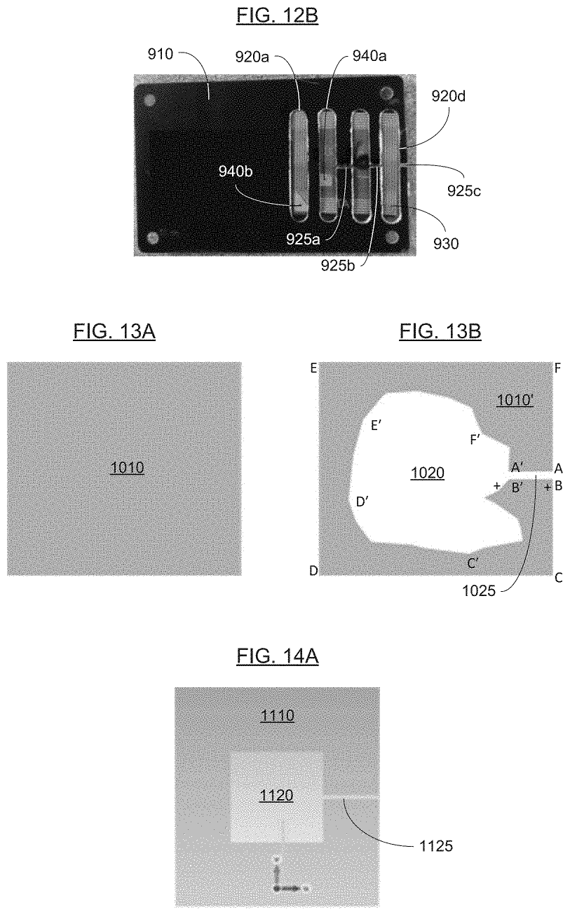

FIG. 12A shows a metal-containing substrate 810 having three cuts or slits 820a-c and a wireless communication tag attached to the substrate 810. The wireless tag may be similar or substantially identical to the wireless tag 115 shown in FIGS. 1A-B. The wireless tag may comprise an antenna 830, an integrated circuit (not visible, but which may include a processor, one or more sensors, a memory, and/or a battery, etc.), and a first connection pad 840 (e.g., to connect the outer end of the antenna 830 to the integrated circuit; a second connection pad configured to connect the outer end of the antenna 830 to a trace or strap that crosses the loops of the antenna 830 that, in turn, is connected to the first connection pad 840 is obscured by the substrate 810). The metal-containing substrate 810 may comprise a metal foil or layer (not shown, but which may comprise, e.g., aluminum, an aluminum alloy, copper, a copper alloy, or stainless steel). The cuts or slits 820a-b are configured to reduce eddy currents in the metal-containing substrate 810 when a wireless signal is transmitted or received by the antenna 830 in the wireless tag. Relatively narrow cross-cuts 825a-b connect each of the cuts or slits 820b-c to the periphery of the substrate 810 and further reduce and/or change the direction of eddy currents in the substrate 810.

The primary cuts or slits 820a-c may be manufactured by milling, stamping, or laser cutting. The cut or slit 820c is aligned with traces of the antenna 830 and is shorter in length than the cuts or slits 820a-b, although the invention is not so limited. The cross-cuts 825a-b may be made with a laser, a blade or a saw, and are much narrower than the primary cuts or slits 820a-c, although the invention is not so limited.

Each of the primary cuts or slits 820a-c may have a width of from 0.2% to 15% of the length of the substrate 810 (or any width or range of widths between 0.2% and 15%; e.g., 8%), and a length of from 50% to 95% of the width of the substrate 810 (or any length or range of lengths between 50% to 95% of the width of the substrate; e.g., 75%). The cuts or slits 820a-c do not extend to the periphery of the substrate 810. In alternative embodiments, the cuts or slits 820a-c may extend to and/or be exposed through the periphery or outermost edge of the substrate 810.

FIG. 12B shows a metal-containing substrate 910 similar to the substrate 810 in FIG. 12A, but having four main or primary cuts or slits 920a-d and three narrow cross-cuts 925a-c therein. A wireless communication tag attached to the substrate 910. The wireless tag may be similar or substantially identical to the wireless tag 115 shown in FIGS. 1A-B and the wireless tag in FIG. 12A. The wireless tag FIG. 12B may comprise an antenna 930, an integrated circuit (not shown, but which may include a processor, one or more sensors, a memory, a battery, etc.), and connection pads 940a-b (e.g., to connect the outer end of the antenna 930 via a trace or strap that crosses the loops of the antenna 930 to the integrated circuit). The metal-containing substrate 910 may comprise a metal foil or layer, similarly or identically to the substrate 810 in FIG. 12A. The cuts or slits 920a-d (which may have equal dimensions) are configured to reduce eddy currents in the metal-containing substrate 910 when a wireless signal is transmitted or received by the antenna 930 in the wireless tag. The narrow cross-cuts 925a-c connect the cuts or slits 920b-d to the periphery of the substrate 910 and further reduce and/or change the direction of the eddy currents. The cuts or slits 920a-d and the cross-cuts 925a-c may be made in the same way as the cuts or slits 820a-b and the cross-cuts 825a-b in FIG. 12A.

Table 2 shows the results of testing the readability (e.g., the maximum distance from which the reader may transmit and receive a signal to and from the wireless tag) of each of the wireless tags shown in FIGS. 12A-B when unattached (i.e., as a stand-alone device) and when attached to the respective substrate 810 or 910. An external capacitance across the antenna terminals of the tag was used to retune the tag to the correct operating frequency.

TABLE 2

| | | Read range mm | | |
|---|---|---|---|---|
| Tag assembly | External cap (pF) | Nexus 5X | Nexus 6 | iPhone 7 |
| Stand-alone | NA | 42.0 | 39.0 | 45.0 |
| Substrate 810 | 82 | 42 | 38.5 | 42.0 |
| Substrate 910 | 82 | 41 | 39.0 | 42.0 |

The readers include the Google Nexus 5X and Nexus 6 smartphones, and the Apple iPhone 7 smartphone. The external capacitance between the wireless tag and each of the substrates 810 and 910 is 82 picofarads. The substrates 810 and 910 did not significantly decrease the readability of the wireless tags using the Nexus 5X or the Nexus 6, if at all, and the readability of the wireless tags using the iPhone 7 by was affected only slightly (about 6.7% relative to the readability of the stand-alone wireless tag, but about the same as or better than the Nexus 5X and Nexus 6). Thus, the wireless tag attached to the metal-containing substrates 810 and 910 is still about as readable as the stand-alone wireless tags.

FIGS. 13A-B show a metal-containing substrate 1010 before and after being cut in an exemplary internal pattern. The pattern 1020 in FIG. 13B is somewhat random and/or arbitrary, as the actual shape of the pattern 1020 is largely irrelevant for purposes of explaining this aspect of the invention. The metal-containing substrate 1010 may comprise aluminum, an aluminum alloy, stainless steel, or another metal such as copper or a copper alloy. The uncut substrate 1010 in FIG. 13A experiences surface eddy currents when placed in an electromagnetic field.

FIG. 13B shows the metal-containing substrate 1010 with a narrow cut 1025 (e.g., bounded by AA′-BB′) connecting a larger internal cut 1020 (e.g., bounded by B′C′D′E′F′A′) to the outermost edge of the substrate 1010. An external magnetic field induces an electromagnetic force (EMF) in both of the loops BCDEFA and B′C′D′E′F′A′ (with polarities shown by the + signs). Since the loops BCDEFA and B′C′D′E′F′A′ are effectively in series with opposing polarities, the net surface current is determined by the difference in EMF in the loops BCDEFA and B′C′D′E′F′A′, divided by the sum of effective surface impedances in each loop BCDEFA and B′C′D′E′F′A′. The difference in EMF between the loops BCDEFA and B′C′D′E′F′A′ approaches zero when the pattern (e.g., internal cut 1020) approaches the dimensions of the substrate 1010. However, to preserve structural integrity of the substrate 1010, a minimum amount of the substrate 1010 is preserved. For a given area, the irregular geometry of the loop B′C′D′E′F′A′ may be used to minimize the surface current(s). In other words, it may be desirable to find an optimum geometry for the pattern 1020 to (i) minimize the difference in EMF between the inner and outer loops B′C′D′E′F′A′ and BCDEFA and/or (ii) maximize the sum of the surface impedances in each of the inner and outer loops B′C′D′E′F′A′ and BCDEFA.

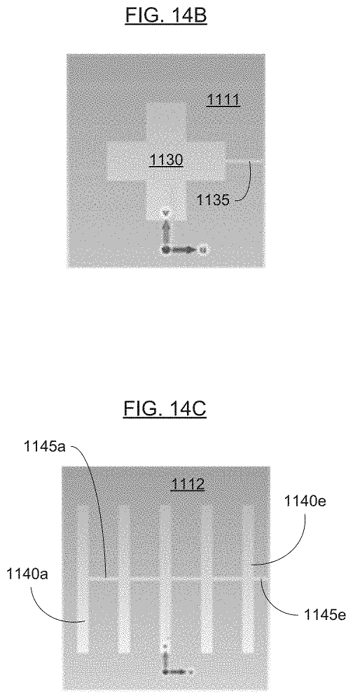

FIGS. 14A-C show exemplary metal-containing substrates each respectively having a square pattern, a cross pattern, and a grating pattern therein (i.e., the pattern of the inner cut). The area of uncut metal (and/or the area of metal removed in the pattern) is the same in each substrate. Each of the pattern geometries was tested for mitigation of surface current (e.g., by testing the readability of a wireless tag using a near field communication [NFC] reader, such as a smartphone).

FIG. 14A shows a substrate 1110 including a square pattern 1120 and a narrow cut 1125 connecting the square pattern 1120 to the outer edge of the substrate 1110. FIG. 14B shows a substrate 1111 including a cross pattern 1130 and a narrow cut 1135 connecting the cross pattern 1130 to the outer edge of the substrate 1111. FIG. 14C shows a substrate 1112 including parallel main cuts or slits 1140a-e and narrow cross-cuts 1145a-e.

The substrate 1112 including the parallel main cuts or slits 1140a-e and cross-cuts 1145a-e (FIG. 14C) has the highest impedance, whereas the substrate 1110 including the square pattern 1120 (FIG. 14A) has the lowest impedance. After testing, the substrate 1110 including the square pattern 1120 (FIG. 14A) had the longest or largest read range, the substrate 1112 including the parallel main cuts or slits 1140a-e and cross-cuts 1145a-e (FIG. 14C) had the second longest or largest read range, and the substrate 1111 including the cross pattern 1130 (FIG. 14B) had the third longest or largest read range. The fact that the substrate 1110 of FIG. 14A has a higher read range than the substrate 1112 of FIG. 14C may be due to better cancellation of EMF's in the substrate 1110 of FIG. 14A.

In further or alternative embodiments, the geometry of the pattern may be determined using a computer algorithm, and the geometry may be irregular or fractal in shape.

### CONCLUSION/SUMMARY

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of reading a wireless communication device, the wireless communication device comprising an antenna, a metal-containing substrate and an integrated circuit on the metal-containing substrate and electrically coupled to the antenna, the method comprising:
placing a reader proximate to a first side of the wireless communication device containing the metal-containing substrate and away from a second side of the wireless communication device containing the antenna, wherein the metal-containing substrate contains one or more openings therethrough, the one or more openings improve a readability of the wireless communication device and/or reduce a magnitude of electromagnetically-induced currents in the metal-containing substrate, and the antenna overlaps with at least one of the one or more openings; and
transmitting or broadcasting one or more wireless signals to the wireless communication device.

2. The method of claim 1, wherein the antenna is parallel with the metal-containing substrate and is not more than 10 mm away from the metal-containing substrate.

3. The method of claim 1, wherein the eddy currents are reduced relative to an otherwise identical metal-containing substrate without the one or more openings.

4. The method of claim 1, wherein the one or more openings comprise a plurality of openings.

5. The method of claim 4, wherein the plurality of openings comprises a radial pattern of cuts or slits.

6. The method of claim 5, wherein the radial pattern further comprises an uncut center or hub, configured to maintain at least some mechanical integrity of the metal-containing substrate.

7. The method of claim 4, wherein the pattern comprises a plurality of parallel cuts or slits.

8. The method of claim 7, wherein the pattern further comprises one or more cross-cuts connecting (i) at least two of the parallel cuts or slits, or (ii) at least one of the parallel cuts or slits with an outermost edge of the metal-containing substrate.

9. The method of claim 1, wherein the reader comprises a near field communication (NFC) reader, and the integrated circuit is configured to (i) receive and process one or more first signals from the antenna and (ii) generate and transmit one or more second signals to the antenna.

10. A wireless communication device, comprising:
an antenna;
an integrated circuit configured to receive one or more first wireless signals from the antenna and to transmit or broadcast one or more second wireless signals using the antenna; and
a metal-containing substrate having one or more openings therethrough, wherein the antenna overlaps with at least one of the one or more openings.

11. The wireless communication device of claim 10, wherein the one or more openings are configured to reduce and/or change a direction of eddy currents in the metal-containing substrate.

12. The wireless communication device of claim 10, wherein the one or more openings comprise a pattern.

13. The wireless communication device of claim 12, wherein the pattern comprises a radial pattern of cuts or slits.

14. The wireless communication device of claim 13, wherein the radial pattern further comprises an uncut center or hub, configured to maintain at least some mechanical integrity of the metal-containing substrate.

15. The wireless communication device of claim 12, wherein the pattern comprises a plurality of parallel cuts or slits.

16. The wireless communication device of claim 15, wherein the pattern further comprises one or more cross-cuts connecting (i) at least two of the parallel cuts or slits or (ii) at least one of the parallel cuts or slits with an outermost edge of the metal-containing substrate.

17. The wireless communication device of claim 10, wherein the metal-containing substrate further comprises one or more cross-cuts connecting at least one of the one or more openings with the outermost edge of the metal-containing substrate.

18. A method of making a wireless communication device, comprising:
forming an integrated circuit on a metal-containing substrate;
forming one or more openings through the metal-containing substrate, the one or more openings improving a readability of the wireless communication device and/or reducing a magnitude of electromagnetically-induced currents in the metal-containing substrate; and
coupling an antenna to the integrated circuit and placing the antenna so that the antenna overlaps with at least one of the one or more openings.

19. The method of claim 18, wherein (i) the readability of the wireless communication device is improved and/or (ii) the magnitude of electromagnetically-induced currents in the metal-containing substrate is reduced relative to an otherwise identical metal-containing substrate without the one or more openings.

20. The method of claim 18, wherein the antenna is parallel with the metal-containing substrate and is not more than 10 mm away from the metal-containing substrate.
